(19) United States
(12) Patent Application Publication
(10) Pub. No.: US 2023/0250205 A1
(43) Pub. Date: Aug. 10, 2023

(54) AQUEOUS DISPERSION OF POLYMER PARTICLES AND MICROSPHERES

(71) Applicant: Rohm and Haas Company, Collegeville, PA (US)

(72) Inventors: James C. Bohling, Lansdale, PA (US); Philip R. Harsh, Birdsboro, PA (US); Christopher Kozak, Audubon, PA (US); Partha S. Majumdar, Harleysville, PA (US)

(21) Appl. No.: 18/015,552

(22) PCT Filed: Jul. 16, 2021
(86) PCT No.: PCT/US2021/042043

§ 371 Date: Jan. 11, 2023

Related U.S. Application Data
(60) Provisional application No. 63/054,378, filed on Jul. 21, 2020.

(51) Int. Cl. C08F 212/08; C08F 220/18; C08F 230/02

(52) U.S. Cl. CPC C08F 212/08; C08F 220/1804; C08F 230/02; C08F 2400/02

(57) ABSTRACT

The present invention is a composition comprising an aqueous dispersion of first and second polymer particles; and polymeric organic crosslinked microspheres; wherein, the weight-to-weight ratio of second polymer particles to first polymer particles is in the range of from 50:50 to 80:20; and wherein the weight-to-weight ratio of the microspheres to the first and second polymer particles is in the range of from 3:97 to 20:80. The composition of the present invention is useful semi-gloss or satin paint formulations with excellent mar resistance.

### BACKGROUND OF THE INVENTION

The present invention relates to an aqueous dispersion of film-forming polymer particles and non-film-forming microspheres, more particularly, at least two kinds of film-forming polymer particles.

Coatings with mar resistance are in demand for high traffic areas such as hallways and stairwells to attenuate surface damage arising from inadvertent contact of items such as clothing, packages, and luggage. Higher sheen (satin) paints, which are often used in these high traffic areas, require incorporation of inorganic extender particles such as nepheline syenite, diatomaceous earth, and calcium carbonate to control gloss to a desired finish; however, marring is exacerbated by the presence of these inorganic extenders, even at the low demand required for satin paints. Accordingly, it would be an advantage in the art of semi-gloss or satin paints to provide a more mar resistant coating, while maintaining the desired properties and targeted gloss.

### SUMMARY OF THE INVENTION

The present invention addresses a need in the art by providing, in a first aspect, a composition comprising an aqueous dispersion of first and second polymer particles having a z-average particle size in the range of from 70 nm to 600 nm; and polymeric organic crosslinked microspheres having a median weight average (D₅₀) particle size in the range of from 0.7 μm to 30 μm;
wherein the first polymer particles are acrylic polymer particles, and the second polymer particles are acrylic, styrene-acrylic, or vinyl ester polymer particles, with the proviso that when the second polymer particles are acrylic particles, one of the first and second polymer particles is functionalized with from 0.1 to 5 weight percent structural units of a phosphorus acid monomer, and the other of the first and second polymer particles is functionalized with less than 0.09 weight percent structural units of a phosphorus acid monomer;
wherein, the weight-to-weight ratio of second polymer particles to first polymer particles is in the range of from 50:50 to 80:20; and
wherein the weight-to-weight ratio of the microspheres to the first and second polymer particles is in the range of from 3:97 to 20:80.

The composition of the present invention provides mar resistance to paint coatings with at least 15 gloss units measured at a 60° angle.

### DETAILED DESCRIPTION OF THE INVENTION

The present invention is a composition comprising an aqueous dispersion of first and second polymer particles having a z-average particle size in the range of from 70 nm to 600 nm; and polymeric organic crosslinked microspheres having a median weight average (D₅₀) particle size in the range of from 0.7 μm to 30 μm;
wherein the first polymer particles are acrylic polymer particles, and the second polymer particles are acrylic, styrene-acrylic, or vinyl ester polymer particles, with the proviso that when the second polymer particles are acrylic particles, one of the first and second polymer particles is functionalized with from 0.1 to 5 weight percent structural units of a phosphorus acid monomer, and the other of the first and second polymer particles is functionalized with less than 0.09 weight percent structural units of a phosphorus acid monomer;
wherein, the weight-to-weight ratio of second polymer particles to first polymer particles is in the range of from 50:50, preferably from 65:35 to 80:20; and
wherein the weight-to-weight ratio of the microspheres to the first and second polymer particles is in the range of from 3:97 to 20:80, preferably from 15:85.

The first polymer particles are acrylic polymer particles, which comprise at least 40, preferably at least 60, more preferably at least 80, and most preferably at least 90 weight percent structural units of one or more methacrylate monomers such as methyl methacrylate and ethyl methacrylate, and/or one or more acrylate monomers such as ethyl acrylate, butyl acrylate, 2-propylheptyl acrylate, and 2-ethylhexyl acrylate.

As used herein, the term “structural unit” of the named monomer refers to the remnant of the monomer after polymerization. For example, a structural unit of methyl methacrylate is as illustrated:

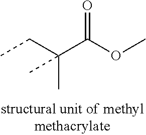

where the dotted lines represent the points of attachment of the structural unit to the polymer backbone.

The acrylic polymer particles may also comprise from 0.1 to 10 weight percent structural units of ethylenically unsaturated carboxylic acid monomers such as methacrylic acid, acrylic acid, and itaconic acid, or salts thereof.

The first polymer particles may also comprise structural units of a phosphorus acid monomer, examples of which include phosphonates and dihydrogen phosphate esters of an alcohol in which the alcohol contains or is substituted with a polymerizable vinyl or olefinic group. Preferred dihydrogen phosphate esters are phosphates of hydroxyalkyl acrylates or methacrylates, including 2-phosphoethyl methacrylate (PEM) and phosphopropyl methacrylates. PEM is a preferred phosphorus acid monomer.

In the case where the second polymer particles are acrylic polymer particles, one of the first and second acrylic polymer particles comprise from 0.1, preferably from 0.5, and more preferably from 1 weight percent, to 5, preferably to 3 weight percent structural units of a phosphorus acid monomer, and the other of the first and second acrylic polymer particles comprise less than 0.09, preferably less than 0.05, more preferably less than 0.01, and most preferably 0 weight percent structural units of a phosphorus acid monomer.

As used herein, styrene-acrylic polymer particles are polymer particles that comprise at least 10, preferably at least 20, and more preferably at least 25 weight percent, to 60, preferably to 50 weight percent structural units of styrene; accordingly, as used herein, acrylic polymers comprise less than 10 weight percent structural units of styrene.

As used herein, vinyl ester polymer particles are polymer particles that comprise at least 40, preferably at least 50, and more preferably at least 60 weight percent structural units of a vinyl ester such as vinyl acetate and vinyl versatate; accordingly, as used herein, acrylic polymers comprise less than 40 weight percent structural units of a vinyl ester.

In the case where the second polymer particles are styrene-acrylic polymer particles or vinyl ester polymer particles, the first polymer particles preferably, but do not necessarily comprise structural units of a phosphorus acid monomer. In one embodiment, the first polymer particles comprise from 0.1, preferably from 0.5, and more preferably from 1 weight percent, to 5, preferably to 3 weight percent structural units of a phosphorus acid monomer; and the second polymer particles are styrene-acrylic or vinyl ester polymer particles.

Acrylic and styrene-acrylic polymeric dispersions typically have a z-average particle size in the range of from 70 nm to 300 nm, while vinyl ester latexes generally have a z-average particle size in the range of from 200 nm to 550 nm, as measured using dynamic light scattering.

The polymeric organic crosslinked microspheres have a median weight average particle size (D₅₀) in the range of from 0.7 μm, preferably from 1 μm, more preferably from 2 μm, and most preferably from 4 μm, to 30 μm, to preferably 20 μm, more preferably to 13 μm, and most preferably to 10 μm, as measured using a Disc Centrifuge Photosedimentometer (DCP). These organic polymeric microspheres are characterized by being non-film-forming and preferably having a low T_{g} crosslinked core, that is, a crosslinked core having a T_{g}, as calculated by the Fox equation, of not greater than 25° C., more preferably not greater than 15° C., and more preferably not greater than 10° C.

The crosslinked core of the polymeric organic crosslinked microspheres preferably comprises structural units of one or more monoethylenically unsaturated monomers whose homopolymers have a T_{g} of not greater than 20° C. (low T_{g} monomers) such as methyl acrylate, ethyl acrylate, n-butyl acrylate, and 2-ethylhexyl acrylate. Preferably, the crosslinked low T_{g} core comprises, based on the weight of the core, from 50, more preferably from 70, more preferably from 80, and most preferably from 90 weight percent, to preferably 99, and more preferably to 97.5 weight percent structural units of a low T_{g} monoethylenically unsaturated monomer. n-Butyl acrylate, and 2-ethylhexyl acrylate are preferred low T_{g} monoethylenically unsaturated monomers used to prepare the low T_{g} core.

The crosslinked core further comprises structural units of a multiethylenically unsaturated monomer, examples of which include allyl methacrylate, allyl acrylate, divinyl benzene, trimethylolpropane trimethacrylate, trimethylolpropane triacrylate, butylene glycol (1,3) dimethacrylate, butylene glycol (1,3) diacrylate, ethylene glycol dimethacrylate, and ethylene glycol diacrylate. The concentration of structural units of the multiethylenically unsaturated monomer in the crosslinked microspheres is preferably in the range of from 1, more preferably from 2 weight percent, to 9, more preferably to 8, and most preferably to 6 weight percent, based on the weight of the core.

The polymeric organic crosslinked microspheres are preferably multistage microspheres comprising a crosslinked core that is clad with high a T_{g} shell, that is, a shell having a T_{g} of at least 50° C., more preferably at least 70° C., and most preferably at least 90° C. The shell preferably comprises structural units of monomers whose homopolymers have a T_{g} greater than 70° C. (high T_{g} monomers), such as methyl methacrylate, styrene, isobornyl methacrylate, cyclohexyl methacrylate, and t-butyl methacrylate. The high T_{g} shell preferably comprises at least 90 weight percent structural units of methyl methacrylate.

The polymeric organic crosslinked microspheres, preferably multistage polymeric organic crosslinked microspheres, preferably further comprise, based on the weight of the microspheres, from 0.05 to 5 percent structural units of a polymerizable organic phosphate represented by the structure of Formula I:

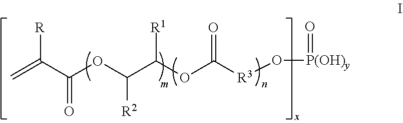

or a salt thereof; wherein R is H or CH₃, wherein R¹ and R² are each independently H or CH₃, with the proviso that CR²CR¹ is not C(CH₃)C(CH₃); each R³ is independently linear or branched C₂-C₆ alkylene; m is from 1 to 10; n is from 0 to 5; with the proviso that when m is 1, then n is from 1 to 5; x is 1 or 2; and y is 1 or 2; and x+y=3.

When n is 0, x is 1, and y is 2, the polymerizable organic phosphate or salt thereof is represented by the structure of Formula II:

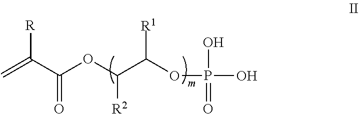

Preferably, each R¹ is H, and each R² is H or CH₃; m is preferably from 3, and more preferably from 4; to preferably to 8, and more preferably to 7. Sipomer PAM-100, Sipomer PAM-200 and Sipomer PAM-600 phosphate esters are examples of commercially available compounds within the scope of the compound of Formula II.

Where n is 1; m is 1; R is CH₃; R¹ and R² are each H; R³ is -(CH₂)₅-; x is 1 or 2; y is 1 or 2; and x+y=3, the polymerizable organic phosphate or salt thereof is represented by the structure of Formula III:

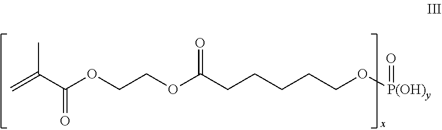

A commercially available compound within the scope of Formula III is Kayamer PM-21 phosphate ester.

The polymeric organic crosslinked microspheres may also comprise 0.05 to 5 weight percent, based on the weight of the microspheres, structural units of an ethylene oxide salt of a distyryl or a tristyryl phenol represented by the structure of Formula IV:

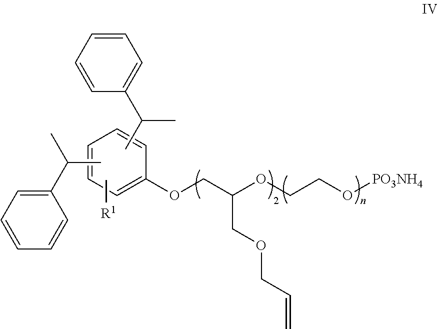

where R¹ is H, CH₂CR═CH₂, CH═CHCH₃, or 1-phenethyl; R is C₁-C₄-alkyl; and n is 12 to 18. A commercial example of the structure of Formula IV is E-Sperse RS-1684 reactive surfactant.

The polymeric organic crosslinked microspheres are distinct from opaque polymers, which comprise water-containing cores that form voided polymer particles after application of the dispersion onto a substrate, followed by evaporation.

The composition may further comprise polyethylene (PE) wax particles, preferably having a z-average particle size by dynamic light scattering in the range of from 0.3 μm, more preferably from 0.8 μm, to preferably 20 μm, more preferably to 15 μm, and most preferably to 10 μm, and at a concentration preferably in the range of from 0.05 to 5 weight percent, based on the weight of the composition. The PE wax can be a low density PE wax, a linear low density PE wax, or a high density PE wax. More preferably, the concentration of the polyethylene wax is in the range of from 0.1 to 3 weight percent, based on the weight of the composition.

The composition of the present invention preferably comprises a substantial absence of inorganic extenders such as talc, clay, mica, sericite, CaCO₃, nepheline, feldspar, wollastonite, kaolinite, dicalcium phosphate, and diatomaceous earth. As used herein, “substantial absence of inorganic extender” means that the weight-to-weight ratio of inorganic extender to polymeric organic multistage crosslinked microspheres is not greater than 1:10, more preferably not greater than 1:20, and most preferably not greater than 1:100. Furthermore, the weight-to-weight ratio of the sum of inorganic extenders and the organic polymeric crosslinked microspheres to the first and second polymer particles is in the range of from 3:97 to 20:80.

The composition advantageously comprises additional materials such as rheology modifiers, coalescents, surfactants, dispersants, defoamers, biocides, opacifying pigments such as TiO₂ and organic opaque polymer particles, colorants, and neutralizing agents.

It has surprisingly been discovered that the composition of the present invention provides improved mar resistance for coatings measured at 60° gloss in the range of from 15, preferably from 20 to 50, preferably to 40, and more preferably to 35 gloss units.

### EXAMPLES

The aqueous dispersion of multistage polymeric organic crosslinked microspheres used in the following examples was prepared as described in US 2019/185687, Intermediate Example 2 [para 0060], and adjusted to 43.5% solids. The particle size was 8.7 μm as measured by DCP, as described in para [0063] of US 2019/185687.

In the following examples PEM-functionalized latex refers to an MMA/BA/MAA/PEM latex that is film-forming at room temperature; RHOPLEX™ VSR 1049 LOE Acrylic Emulsion is a latex with spherical morphology that is not functionalized with a phosphorus acid monomer; ROVACE 10 Vinyl Acrylic Emulsion is a vinyl acrylate/butyl acrylate latex; and EXP-152 ER Binder is a styrene/butyl acrylate latex. RHOPLEX, and ROVACE are Trademarks of The Dow Chemical Company or its Affiliates.

### Intermediate Example 1—General Procedure for Preparation of Mixture of Primary Latex with Organic Microspheres

A blend of multistage polymeric organic crosslinked microspheres, PEM-functionalized latex, Michem Guard 1350 polyethylene wax, and ACRYSOL™ ASE-60 Rheology Modifier were combined, mixed thoroughly, and stored for future use. The latex and microspheres were blended at a 62.5:37.5 ratio based on polymer solids of the individual constituents. The solids content of Intermediate Example 1 was 44.5 weight percent.

### Examples 1-3—General Procedure for Preparation of Paints with Polymeric Microspheres

Intermediate 1 and a secondary latex were mixed together in a 0.50 liter plastic container using an overhead stirrer. Kronos 4311 TiO₂ slurry (TiO₂) was added slowly to the above dispersion and the pH was adjusted with ammonia. The stirring speed was adjusted to ensure adequate mixing, which was continued for 10 min Next, BYK-022 Defoamer (Defoamer) and Texanol Coalescent (Coalescent) were added slowly to the mixture and mixing was continued for an additional 2 to 3 min The stirring speed was increased, at which time ACRYSOL™ RM-1600 Rheology Modifier (RM-1600) was added slowly, followed by addition of ACRYSOL™ RM 725 Rheology Modifier (RM-725) and water. (ACRYSOL is a Trademark of The Dow Chemical Company or its Affiliates.) Mixing was continued for an additional 10 min. The final mixture was a pigmented, microsphere containing paint. Table 1 illustrates the materials used to prepare the Example paint compositions and their amounts. The Example 1 Secondary Latex was RHOPLEX™ VSR 1049 Acrylic Emulsion; the Example 2 Secondary Latex was ROVACE 10 Vinyl Acrylic Emulsion; and the Example 3 Secondary Latex was EXP-152 ER Binder (EXP-152 ER).

TABLE 1
Example Paint Compositions

| Materials | Ex. 1 Wt (g) | Ex. 2 Wt (g) | Ex. 3 Wt (g) |
|---|---|---|---|
| Intermediate 1 | 80.24 | 81.63 | 77.95 |
| VSR-1049 LOE | 218.39 | 0.00 | 0.00 |
| ROVACE 10 | 0.00 | 198.14 | 0.00 |
| EXP-152 ER | 0.00 | 0.00 | 208.13 |
| TiO₂ | 164.26 | 164.26 | 164.26 |
| Ammonia (28%) | 0.00 | 0.41 | 0.18 |
| Defoamer | 0.50 | 0.50 | 0.50 |
| Coalescent | 6.28 | 7.49 | 2.95 |
| RM-1600 | 2.86 | 3.93 | 7.45 |
| RM-725 | 0.94 | 1.95 | 2.56 |
| Water | 53.51 | 70.95 | 59.28 |

### Comparative Examples 1-3—General Procedure for Preparing Comparative Paints with Inorganic Extenders

TiO₂ slurry was slowly added to a secondary latex dispersion in a 0.5-L plastic container with mixing using an overhead stirrer and the pH was adjusted with ammonia. Mixing was continued for 10 min Separately, a FlackTek Speed Mixer was used to disperse solid inorganic extender powders in a grind stage. The ingredients in the grind, water, TAMOL™ 165A Dispersant (Dispersant, A Trademark of The Dow Chemical Company or Its Affiliates), Minex 4 Inorganic Extender (Minex 4), and Diafil 525 Inorganic Extender (Diafil 525) were weighed into a container and mixed at 2900 rpm for 30 s. The container side walls were scraped and mixing was continued at 3000 rpm for 2 min. This grind was added to the TiO₂/latex binder mixture after the 10-min mixing time had elapsed. Next, the defoamer and coalescent were added slowly to the mixture and mixing was continued for an additional 2 to 3 min. The stirring speed was increased and RM-1600 was added slowly, followed by the addition of RM-725 and water were added. Mixing was continued for an additional 10 min. The final mixture was a pigmented paint formulated with inorganic extenders. Table 2 illustrates the materials used to prepare the Comparative Example paint compositions and their amounts. Only one latex was used in each of the comparative Example paints formulations. Comparative Example 1 Paint contained RHOPLEX™ VSR 1049 Acrylic Emulsion; Comparative Example 2 Paint contained ROVACE 10 Vinyl Acrylic Emulsion; and Comparative Example 3 Paint contained EXP-152 ER.

TABLE 2
Comparative Example Paint Formulations

| | Comp. Ex. 1 | Comp. Ex. 2 | Comp. Ex. 3 |
|---|---|---|---|
| Materials | Wt. (g) | Wt. (g) | Wt. (g) |
| Stage: Grind | | | |
| Water | 18.00 | 18.00 | 18.00 |
| Dispersant | 0.64 | 0.64 | 0.64 |
| Minex 4 | 16.55 | 16.55 | 16.55 |
| Diafil 525 | 6.92 | 6.92 | 6.92 |
| Stage: Let Down | | | |
| VSR-1049 LOE | 269.29 | 0.00 | 0.00 |
| ROVACE 10 | 0.00 | 245.75 | 0.00 |
| EXP-152 ER BINDER | 0.00 | 0.00 | 254.22 |
| TiO₂ | 164.26 | 164.26 | 164.26 |
| Ammonia (28%) | 0.32 | 0.34 | 0.16 |
| Defoamer | 0.50 | 0.50 | 0.50 |
| Coalescent | 3.96 | 5.41 | 0.00 |
| ACRYSOL ™ RM-1600 | 7.64 | 7.86 | 11.15 |
| ACRYSOL ™ RM-725 | 2.33 | 9.76 | 4.26 |
| Water | 49.61 | 67.11 | 58.79 |

### Measurement of Gloss

Gloss was measured by the following procedure: Drawdowns of the coatings were prepared at 25° C. and 50% relative humidity (RH) using a 3-mil bird applicator over a white Leneta chart. The coatings were dried for 24 h at 25° C. and 50% RH before performing gloss measurements. ASTM D-523 was followed to measure gloss values using a BYK micro-TRI-gloss meter. Gloss 60° refers to the measured gloss values at a 60° angle.

### Metal Marking Test Method

A 7-mil Dow bar on a Leneta vinyl chart was used to cast a film of the paint to be tested using. The film was allowed to dry at 70° F/50% RH for 5 d, after which time 3.8-cm×11.4-cm samples were cut out for each coated paint to be tested. Felt pads (15 mm×15 mm) were wrapped with an aluminum foil strip (45 mm×17 mm) with shiny side facing out and tape ends together to secure the foil to the pad. The foil wrapped pad was placed into a Veslic Colorfastness Abrasion Tester so that the direction of wrapping was in line with the linear path of abrasion, and the foil wrapped pad was dragged along the surface of the coating using a 500-g load for 30 cycles. Samples were rated on a scale of 0 to 5 units for intensity of metal marking. Rating Examples: 0=film damage, 1=heavy marking, 5=no marking

### Denim Marking Test Method

Coated samples were prepared as described for the metal marking test. Strips of blue denim (42 mm×17 mm) were cut. A modified felt pad (14 mm×14 mm) was wrapped with the denim and tested with a Veslic Colorfastness Abrasion Tester under a 500-g load for 30 cycles. The denim wrapped pad was placed into the abrasion tester so that the denim was wrapped in line with linear path of abrasion. The denim was held into place with the weight of the 500-g load. The same felt pad was used for all samples. Rate samples on a scale of 0 to 5 units for intensity of denim marking. Rating Examples: 0=film damage, 1=heavy marking, 5=no marking. Table 5 illustrates the 60° gloss for each coating. Blending ratio refers to w/w ratio of Intermediate 1 to Secondary Latex. Table 3 illustrates the Gloss Profile for the paint samples.

TABLE 3
Gloss Profile

| Example # | Blending Ratio (w/w) | Gloss 60°, 1 d |
|---|---|---|
| Ex. 1 | 25/75 | 24.5 ± 0.1 |
| Comp. Ex. 1 | 0/100 | 25.7 ± 0.2 |
| Ex. 2 | 25/75 | 23.4 ± 0.7 |
| Comp. Ex 2 | 0/100 | 30.1 ± 0.1 |
| Ex. 3 | 30/70 | 32.9 ± 0.1 |
| Comp. Ex. 3 | 0/100 | 29.7 ± 0.4 |

All the gloss profiles are comparable to each other. Table 4 illustrates mar performance for each coating.

TABLE 4
Mar Resistance Rating

| Example # | Metal Marking Rating | Denim Marking Rating |
|---|---|---|
| Ex. 1 | 3 | 4 |
| Comp. Ex. 1 | 2 | 1 |
| Ex. 2 | 3 | 4 |
| Comp. Ex. 2 | 1 | 2 |
| Ex. 3 | 3 | 4 |
| Comp. Ex. 3 | 2 | 1 |

The data show that semi-gloss or satin coatings prepared from paints containing the polymeric organic crosslinked microspheres show exceptional mar resistance to metal and denim as compared with paints containing inorganic extenders.

1. A composition comprising an aqueous dispersion of first and second polymer particles having a z-average particle size in the range of from 70 nm to 600 nm; and polymeric organic crosslinked microspheres having a median weight average (D₅₀) particle size in the range of from 0.7 μm to 30 μm;
wherein the first polymer particles are acrylic polymer particles, and the second polymer particles are acrylic, styrene-acrylic, or vinyl ester polymer particles, with the proviso that when the second polymer particles are acrylic particles, one of the first and second polymer particles is functionalized with from 0.1 to 5 weight percent structural units of a phosphorus acid monomer, and the other of the first and second polymer particles is functionalized with less than 0.09 weight percent structural units of a phosphorus acid monomer;
wherein, the weight-to-weight ratio of second polymer particles to first polymer particles is in the range of from 50:50 to 80:20; and
wherein the weight-to-weight ratio of the microspheres to the first and second polymer particles is in the range of from 3:97 to 20:80.

2. The composition of claim 1 wherein the first and second polymer particles have a z-average particle size in the range of 70 nm to 300 nm, wherein the second polymer particles are styrene-acrylic polymer particles; wherein the weight-to-weight ratio of second polymer particles to first polymer particles is in the range of from 65:35 to 80:20; and wherein the weight-to-weight ratio of the microspheres to the first and second polymer particles is in the range of from 3:97 to 15:85.

3. The composition of claim 2 wherein the first polymer particles are functionalized with from 0.5 to 5 weight percent structural units of a phosphorus acid monomer which is 2-phosphoethyl methacrylate.

4. The composition of claim 1 wherein the second polymer particles are vinyl ester polymer particles having a z-average particle size in the range of from 200 nm to 550 nm; wherein the weight-to-weight ratio of second polymer particles to first polymer particles is in the range of from 65:35 to 80:20; and wherein the weight-to-weight ratio of the microspheres to the first and second polymer particles is in the range of from 3:97 to 15:85.

5. The composition of claim 4 wherein the first polymer particles are functionalized with from 0.5 to 5 weight percent structural units of a phosphorus acid monomer which is 2-phosphoethyl methacrylate.

6. The composition of claim 1 wherein first and second polymer particles are acrylic polymer particles having a z-average particle size in the range of 70 nm to 300 nm; wherein the first polymer particles are functionalized with from 0.5 to 5 weight percent structural units of a phosphorus acid monomer which is 2-phosphoethyl methacrylate; wherein the second polymer particles comprise less than 0.05 weight percent structural units of a phosphorus acid monomer; wherein the weight-to-weight ratio of second polymer particles to first polymer particles is in the range of from 65:35 to 80:20; and wherein the weight-to-weight ratio of the microspheres to the first and second polymer particles is in the range of from 3:97 to 15:85.

7. The composition of claim 1 which comprises a substantial absence of inorganic extenders, wherein the polymeric organic crosslinked microspheres are multistage polymeric organic crosslinked microspheres having a crosslinked core having a T_{g} of not greater than 15° C. and a shell covering the core that comprises greater than 90 weight percent structural units of methyl methacrylate; wherein the microspheres have a D₅₀ particle size in the range of from 2 μm to 20 μm; wherein the weight-to-weight ratio of second polymer particles to first polymer particles is in the range of from 65:35 to 80:20; and wherein the weight-to-weight ratio of the microspheres to the first and second polymer particles is in the range of from 3:97 to 15:85.

8. The composition of claim 7 wherein the multistage polymeric organic crosslinked microspheres further comprise, based on the weight of the microspheres, either a) from 0.05 to 5 percent structural units of a polymerizable organic phosphate represented by the structure of Formula I: 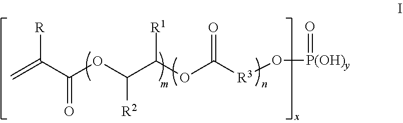
or a salt thereof; wherein R is H or CH₃, wherein R¹ and R² are each independently H or CH₃, with the proviso that CR²CR¹ is not C(CH₃)C(CH₃); each R³ is independently linear or branched C₂-C₆ alkylene; m is from 1 to 10; n is from 0 to 5; with the proviso that when m is 1, then n is from 1 to 5; x is 1 or 2; and y is 1 or 2; and x+y=3; or
b) from 0.05 to 5 weight percent, based on the weight of the microspheres, structural units of an ethylene oxide salt of a distyryl or a tristyryl phenol represented by the structure of Formula IV: 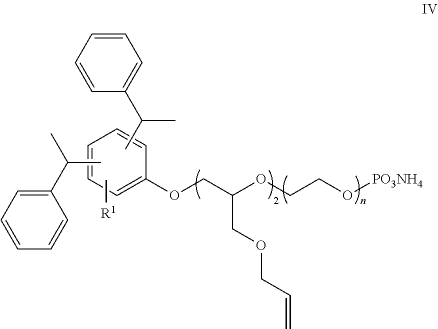
where R¹ is H, CH₂CR═CH₂, CH═CHCH₃, or 1-phenethyl; R is C₁-C₄-alkyl; and n is 12 to 18.

9. The composition of claim 7 where in the weight-to-weight ratio of inorganic extender to polymeric organic multistage crosslinked microspheres is not greater than 1:100, wherein the composition further comprises a rheology modifier, a coalescent, a surfactant, a defoamer, and an opacifying pigment.

10. The composition of claim 1 which further comprises a rheology modifier, a coalescent, a surfactant, a defoamer, an opacifying pigment, and a substantial absence of inorganic extender, wherein the composition, when applied to a substrate and dried, forms a coating with a gloss rating of 15 to 50 gloss units measured at a 60° angle.
